(19) United States
(12) Patent Application Publication
(10) Pub. No.: US 2010/0005341 A1
(43) Pub. Date: Jan. 7, 2010

(54) AUTOMATIC DETECTION AND NOTIFICATION OF TEST REGRESSION WITH AUTOMATIC ON-DEMAND CAPTURE OF PROFILES FOR REGRESSION ANALYSIS

(75) Inventors: Piyush Agarwal, Cary, NC (US); Christopher James Blythe, Raleigh, NC (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 12/166,345

(22) Filed: Jul. 2, 2008

(51) Int. Cl. G06F 11/36

(52) U.S. Cl. 714/38; 714/E11.207

(57) ABSTRACT

A system for automating certain processes of regression testing. One or more regression test cases are executed on a current build of a test application. Current application performance data are collected as a result of execution of the one or more test cases.

The current performance data are compared with baseline performance data obtained by executing the test cases on an earlier built of the test application. If it is determined that a current performance datum is worse than the corresponding baseline performance datum by exceeding a prescribed threshold, then the regression test cases are executed on the current application build under control of a profiler to collect application data for analyzing the source of the performance regression.

### BACKGROUND OF THE INVENTION

This invention relates to regression testing of programming applications and apparatus such as integrated circuits under development. More particularly, it relates to automating regression testing processes that, until now, have been manual operations

Regression testing is a development process in which a developer creates test cases upon completion of a change to software code in the case of software development, or to photolithography patterns, for example, in the case of IC technology. The developer executes the test cases on the software or apparatus to determine if the code or apparatus functions in essentially the same manner as before the changes. That is, the goal of regression testing is to determine if the changes negatively affect the old functions, rather than testing any new functions.

With respect to software changes, for example, it has been noticed during performance testing that the benchmark performance sometimes has markedly regressed over previous builds or set baselines. Although the gathering of benchmark results is automated in the prior art, the detection of performance regression is still a manual process in which a tester compares the current benchmark scores to previous build benchmarks. If a regression is found, then further analysis is needed to discover the source of the regression. The benchmarks are re-run using appropriate profilers, such as jprof, tprof, Rational PurifyPlus, etc) to generate new profiles that can then be analyzed to identify the source of the regression. IProf is an acronyn for a portable industrial-strength interactive profiler for C++ and C. IProf is very familiar to software developers; the program is available on the Internet along with documentation of its use. TProf is a similar software profiling tool also very familiar to developers. Rational PurifyPlus is a tool available from IBM for software runtime analysis that includes memory corruption detection, memory leak detection, and application performance profiling. The entire process of the regression detection and generation of profiles is quite tedious and time consuming.

Consequently, there is a need in the art for an improved regression testing, detection and profile generation environment that tightly integrates the processes to ensure a more efficient approach to regression testing.

### BRIEF SUMMARY OF THE INVENTION

A system, method and storage medium for automating certain processes of regression testing. One or more regression test cases are executed on a current build of a test application. Current application performance data are collected as a result of execution of the one or more test cases.

The current performance data are compared with baseline performance data obtained by executing the test cases on an earlier built of the test application. If it is determined that a current performance datum is worse than the corresponding baseline performance datum by exceeding a prescribed threshold, then the regression test cases are executed on the current application build under control of a profiler to collect application profile data for analyzing the source of the performance regression.

In the event that a current performance datum is worse than the corresponding baseline performance datum by exceeding a prescribed threshold, then an alert signal is also sent to a test operator. Preferably the alert signal is an email message. Also preferably, if a current performance datum is worse than the corresponding baseline performance datum by exceeding a prescribed threshold, then the regression test cases are also executed on the baseline build under control of the same profiler to collect additional application data for analyzing the source of the performance regression. A notification message is also sent to an operator when additional data is collected and stored by the profiler.

### BRIEF DESCRIPTION OF THE DRAWINGS

In the drawing,

FIG. 1 is a conceptual block diagram of a regression testing environment;

FIG. 2 shows the relationships of a control computer and a test computer in the regression testing environment;

FIG. 3 shows a flowchart of the automated regression test process steps performed at the control computer; and

FIGS. 4 through 7 show further process steps of subroutines called from the flowchart of FIG. 3

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wire line, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the operator's computer, partly on the operator's computer, as a stand-alone software package, partly on the operator's computer and partly on a remote computer or entirely on the remote computer or server. In the latter scenario, the remote computer may be connected to the operator's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

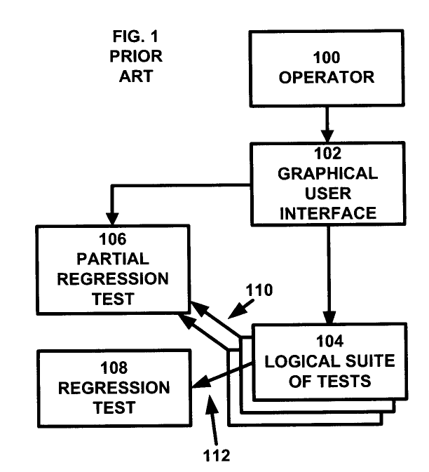

FIG. 1 illustrates an example of a regression testing system. This system is used to perform regression testing in a manner that requires extensive manual operations by a human operator 82. For example, the operator must examine the captured benchmark data and analyze it to detect a regression. In the event that a regression is detected, the operator must then re-run the tests with a profiler to capture trace and memory dump data for analysis. Generated test cases are stored in a memory 104 as a suite of test cases for later regression testing. In regression testing 108, a standard set of reusable test cases 104 are used during the testing In partial regression testing 106, any sub-test section 110 of the test suite 104 may be used to test a functional area (i.e., group of forms within a database, an application within a larger tool suite, etc.).

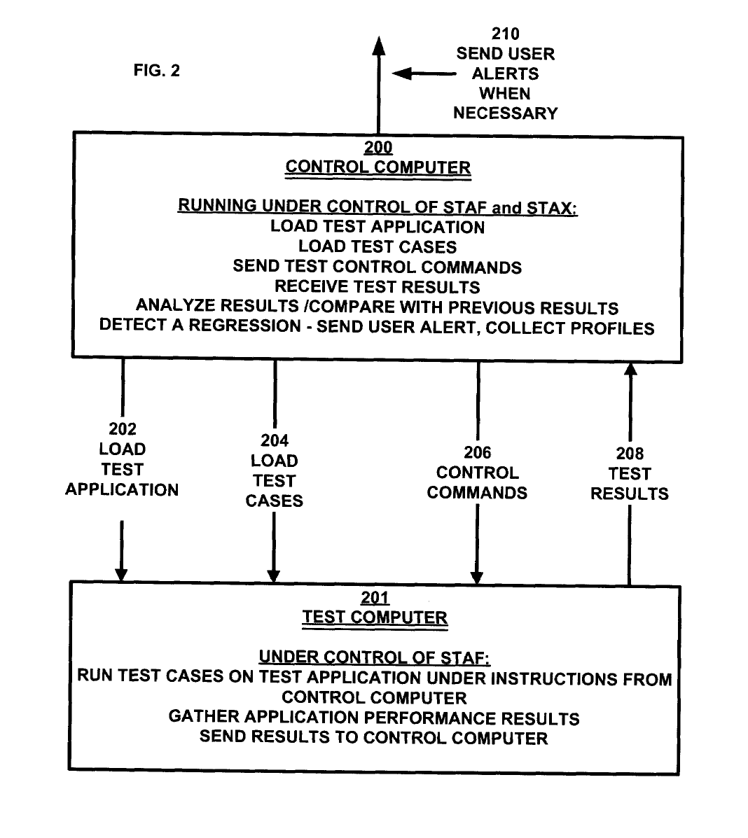

Referring to FIG. 2 in connection with FIG. 1, the testing environment comprises a control computer 200 that contains the application to be tested, the regression test cases and a script program in an embodiment that controls all operations with a test computer 201, including sequencing commands that control the order of operations of the test computer. Under the initial control of the operator 100, the control computer sends a command at 206 to prepare the test computer to receive the test application 202 and the test cases 204. The test cases are a partial subset of the test suite or the full suite as requested by operator 100. These are transmitted to the test computer at 202 and 204. The control computer 200 then sends data to initialize the test application as needed, followed by a command via 206 to begin the test sequencing. The test application is automatically exercised using the test cases earlier downloaded into the test computer. As each test case is performed, the performance data are collected as dictated by each test case. Types of performance data typically include such information as transaction rate (no. of transactions/sec), average response time (seconds taken per response), etc. The performance data is transmitted to the control computer at 208, either as each test completes or as a total block of data when all test cases are completed.

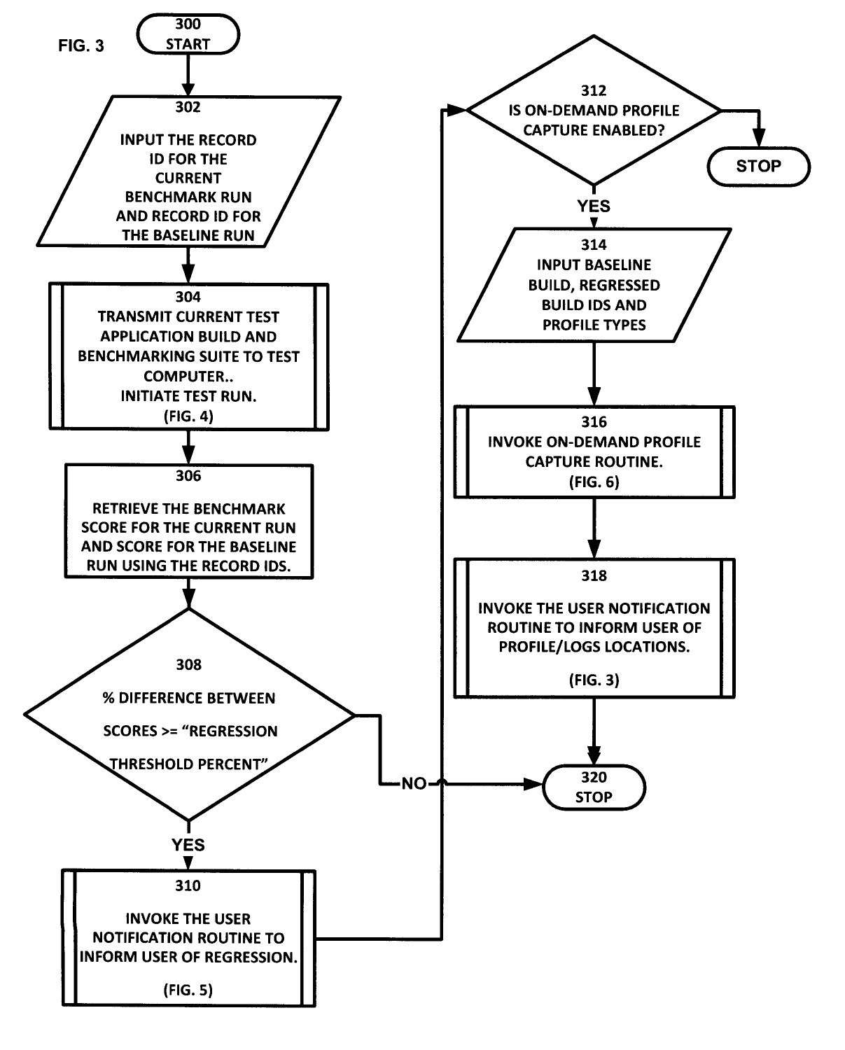

In accordance with the invention, the performance data are automatically analyzed by the control computer 200 by comparing the present performance data with test results obtained on a previous run of the test application and the test cases. These operations are described in detail in FIGS. 3 through 7.

In an embodiment, the invention is implemented using test automation tools such as STAF and STAX executing on the control computer 200 and STAF executing on the test computer 201. The Software Testing Automation Framework (STAF) is an open source, multi-platform, multi-language framework that uses reusable components, called services, to control process invocation and monitoring. STAX is an execution engine which helps to automate the distribution, execution, and results analysis of test cases. Both of these systems are available at sourceforge.net.

In operation, the invention uses baseline results from an earlier build of the test application to compare with the results of the current build. Both sets of results are stored in text files, which might be a CSV (comma separated values) file, or a spreadsheet file or, preferably, a DB2 database file (DB2 is a trademark of IBM). The operator 100 specifies a regression percentage value that is used by the control computer to automatically detect a regression. When a performance result of a test on the present build is worse by the value of the regression percentage, this signals a regression. Of course, there can be a number of regression percentage values, each for a different type of performance data as exemplified above.

When regression testing ends and the performance data gathered at the control computer 200, a regression detection routine is called. The regression detection routine queries the current build's benchmark performance data and the baseline performance data in the respective results file or database and computes the percentage difference between the two runs with respect to each function that is measured in the test cases. If a percentage difference is greater or equal to the specified regression percentage, then a regression has been detected. The regression detection routine notifies the control computer 100, which in turn, notifies the operator 100 that a regression is detected on the build and that profile capture is going to be invoked if profile capture is enabled. Preferably, a simple email alert is used for the operator alert, but any type of alert might be desired.

If a percentage difference is less than the specified regression percentage, then it is considered that a regression has not been detected.

If a regression is detected and profile capture is enabled, a regression detection routine will invoke the profile capture routine and pass to it the baseline build identifier, the current build identifier and the profiler to be used to gather profile data. A profiler typically stores program execution trace information and memory dumps that are used to analyze the regression. The profile capture routine uses the inputs to re-run the benchmark tests and capture specified profile data on both be baseline build and the current build.

Once the capture tasks complete, the profile capture routine invokes a notify operator routine

The notify operator routine notifies the operator preferably via email that a profiles capture for the regression has been completed and that the logged profile data are placed at a specified location in a repository for further analysis.

With reference to FIG. 2, in the disclosed embodiment, control computer 200 is running under the control of STAF and STAX. STAF and STAX cause the control computer 200 to send commands from a script to control the operations of the test computer 201. Specifically, control computer 200 transmits the test application build and test cases to the test computer 201; it initiates the execution of the test cases, it receives the benchmark results when benchmarking is completed and it analyzes the benchmark results with respect to the specified regression threshold or thresholds. If a regression is detected, the operator is notified and the test computer is automatically controlled to re-run the tests on both the previous build and the current build to collect profiles for analysis. When the profile data are available, the operator is notified of the availability and the location of the stored profiles.

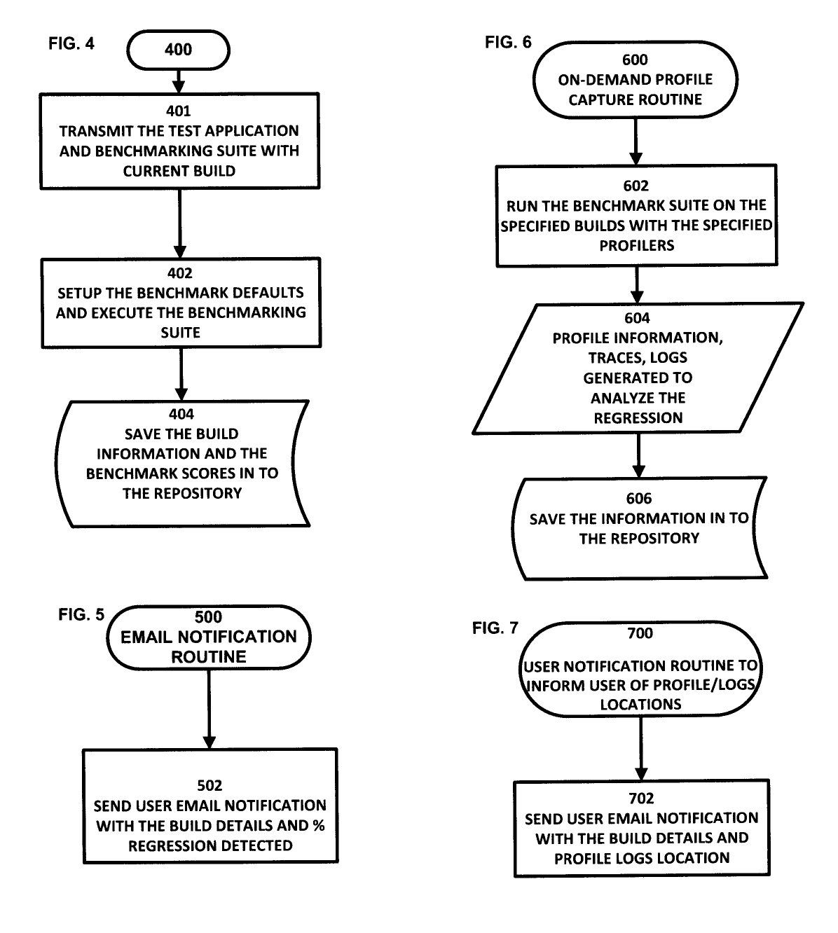

FIG. 3 shows the control computer 200 process steps in more detail. Operation begins at 300. At 302, the computer receives from the operator identifications that identify the current build and test run and the previous (the baseline) test results. Step 304 calls a subroutine shown in FIG. 4 to transmit the current application build and the test cases to the test computer 301, and to initiate the execution of the test cases. With reference to FIG. 4, step 401 transmits the test application and the test cases to the test computer; step 402 initializes the test application as needed to begin the testing and signals the test computer to begin. Step 404 receives the test results and stores the data in a repository using the assigned test identification.

Returning to FIG. 3, step 306 retrieves the current benchmark results and the previous benchmark results from the repository. Step 308 compares the previous and current results to determine if any performance has worsened by an amount exceeding the specified threshold value. If no regression is detected, the testing process is complete and execution stops at 320. If 308 detects a regression, step 310 calls a subroutine, shown in more detail in FIG. 5, to alert the operator. In FIG. 5, step 500 sends an email alert or other alert to the operator that includes build details, the failing test and the percent of regression. Returning to FIG. 3, if the operator has specified that profile capture is enabled, then step 314 is executed to fetch the necessary information to re-run both the previous baseline tests and the current tests and to capture profile information during the test runs for analysis. Step 316 calls a subroutine, shown in FIG. 6, to invoke the profile capture. With reference to FIG. 6, step 602 runs the test cases using both the previous build and the current build and uses the specified profile program at 604 to capture the specified profile and trace information for analysis. Step 606 stores the captured information in the repository.

Step 318 of FIG. 3 next calls a subroutine shown in FIG. 7 where step 702 generates an email to notify the operator that profiles have been captured and their locations.

Having thus described the invention of the present application in detail and by reference to embodiments thereof, it will be apparent that modifications and variations are possible without departing from the scope of the invention defined in the appended claims.

What is claimed is:

1. A method for automating processes of regression testing, comprising
executing at least one regression test case on a current build of a test application,
collecting current application performance data as a result of execution of the at least one test case,
comparing the current performance data with baseline performance data obtained by executing the at least one test case on an earlier built of the test application,
determining if a current performance datum is worse than the corresponding baseline performance datum by exceeding a prescribed threshold,
in response to determining that the current performance datum is worse than the corresponding baseline performance datum by exceeding a prescribed threshold, executing the regression at least one test case on the current application build under control of a profiler to collect application profile data for analyzing the source of the performance regression.

2. The method of claim 1 further comprising
in response to determining that the current performance datum is worse than the corresponding baseline performance datum by exceeding a prescribed threshold, sending an alert signal to a test operator.

3. The method of claim 2 wherein the alert signal is an email message.

4. The method of claim 1 further comprising
in response to determining that the current performance datum is worse than the corresponding baseline performance datum by exceeding a threshold amount, executing the at least one regression test case on the baseline build under control of the same profiler to collect baseline application profile data for analyzing the source of the performance regression.

5. The method of claim 1 or claim 4 further comprising
sending a notification to an operator when additional data is collected and stored by the profiler.

6. A computer-readable storage medium containing program code for automating certain processes of regression testing, comprising
code for executing at least one regression test case on a current build of a test application,
code for collecting current application performance data as a result of execution of the at least one test case,
code for comparing the current performance data with baseline performance data obtained by executing the at least one test case on an earlier built of the test application,
code for determining if a current performance datum is worse than the corresponding baseline performance datum by exceeding a prescribed threshold,
code, responsive to a determining that the current performance datum is worse than the corresponding baseline performance datum by exceeding a prescribed threshold, for executing the at least one regression test case on the current application build under control of a profiler to collect application profile data for analyzing the source of the performance regression.

7. The medium of claim 6 further comprising
code responsive to a determining that the current performance datum is worse than the corresponding baseline performance datum by exceeding a prescribed threshold, for sending an alert signal to a test operator.

8. The medium of claim 7 wherein the alert signal is an email message.

9. The medium of claim 6 further comprising
code responsive to a determining that the current performance datum is worse than the corresponding baseline performance datum by exceeding a threshold amount, for executing the regression test cases on the baseline build under control of the same profiler to collect baseline application profile data for analyzing the source of the performance regression.

10. The medium of claim 6 or claim 9 further comprising
code for sending a notification to an operator when additional data is collected and stored by the profiler.

11. A computer system for automating certain processes of regression testing, comprising
a test computer for executing regression tests on an application build,
a control computer for controlling the operations of the test computer,
means in the control computer for collecting application performance data as a result of execution of at least one test case on the test computer,
means in the control computer for comparing the performance data with baseline performance data obtained by executing the at least one test case on an earlier built of the test application,
means in the control computer for determining if the current performance datum is worse than the corresponding baseline performance datum by exceeding a prescribed threshold,
in response to determining that the current performance datum is worse than the corresponding baseline performance datum by exceeding the threshold, means for executing the at least one regression test case on the current application build under control of a profiler to collect application profile data for analyzing the source of the performance regression.

12. The system of claim 11 further comprising
means responsive to a determination that the current performance datum is worse than the corresponding baseline performance datum by exceeding a prescribed threshold, for sending an alert signal to a test operator.

13. The system of claim 12 wherein the alert signal is an email message.

14. The system of claim 11 further comprising
means response to determination that the current performance datum is worse than the corresponding baseline performance datum by exceeding a prescribed threshold, executing the at least one regression test case on the baseline build under control of the same profiler to collect baseline profile data for analyzing the source of the performance regression.

15. The system of claim 11 or claim 14 further comprising
means for ending a notification to an operator when additional data is collected and stored by the profiler.
